(19) United States
(12) Patent Application Publication
(10) Pub. No.: US 2007/0159844 A1
(43) Pub. Date: Jul. 12, 2007

(54) Candle-like lamp

(76) Inventor: Roger Wang, Taipei (TW)

Correspondence Address: LEONG C LEI, PMB # 1008, 1867 YGNACIO VALLEY ROAD, WALNUT CREEK, CA, 94598, US

(21) Appl. No.: 11/327,537

(22) Filed: Jan. 9, 2006

(51) Int. Cl. F21V 5/00

(52) U.S. Cl. 362/569

(57) ABSTRACT

A candle-like lamp having a light-transmitted body is disclosed. The light-transmitted body comprises a heat isolation seat body, a light-emitting source and a candle-like lamp shade, characterized in that the heat isolation seat body has an upper end which is a protruded mounting edge and has a tapered axle hole; the light-emitting source is hidden within the interior of the axle hole but is lower than the horizontal face of the top upper end of the protruded mounting edge; and the candle-like lamp shade is cylindrical and has an upper end which is recessed and can hold a liquid and is mounted onto the protruded mounting edge of the heat-isolation seat body.

### BACKGROUND OF THE INVENTION

(a) Technical Field of the Invention

The present invention relates to a lamp, and in particular, a lamp having the shape of a candle, and having a transparent body.

(b) Description of the Prior Art

Conventional lamp employs glass or plastic material as the light transmitting body and therefore, the transmitted light will not as soft or natural as that of a candle.

Light from candle is always soft and is regarded as a harmonious light for a room. Unless the light of the room is from candles, there is a best substitution for candle. However, it is not possible and not practical to use candle for a long period under air-conditioned environment. Accordingly, it is an object of the present invention to provide a candle-like lamp with a transparent body having candle properties.

### SUMMARY OF THE INVENTION

The primary purpose of the present invention is to provide a candle-like lamp having a light transmitted body comprises a heat isolation seat body, a light-emitting source and a candle-like lamp shade, characterized in that the heat isolation seat body has an upper end which is a protruded mounting edge and has a tapered axle hole; the light-emitting source is hidden within the interior of the axle hole but is lower than the horizontal face of the top upper end of the protruded mounting edge; and the candle-like lamp shade is cylindrical and has an upper end which is recessed and can hold a liquid and is mounted onto the protruded mounting edge of the heat-isolation seat body.

Another object of the present invention is to provide a candle-like lamp wherein the light that transmitted via the transparent body alike that of a candle.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the candle-like lamp with a light transmitted body in accordance with the present invention.

FIG. 2 is a preferred embodiment of the present invention.

FIG. 3 is a schematic view showing the combination of the heat-isolation seat body and the light-emitting source in accordance with the present invention.

FIG. 4 is a candle-like lampshade in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

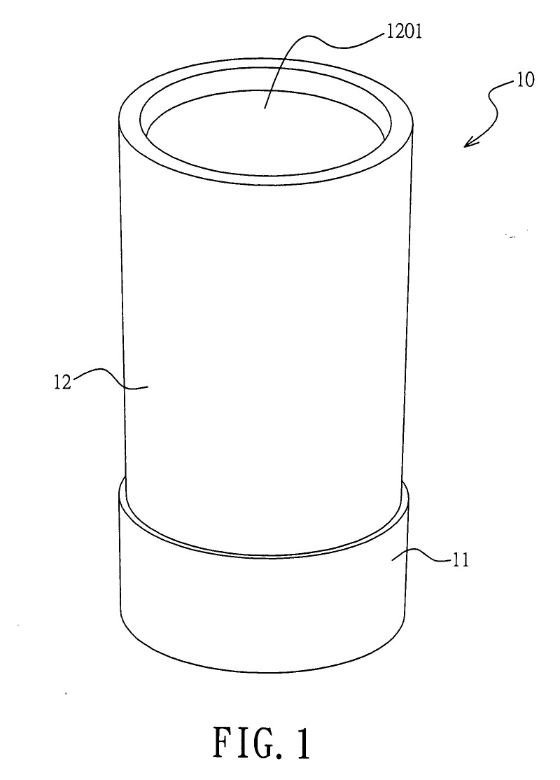

Referring to FIG. 1, there is shown a perspective view of a candle-like light-transmitted body 10 includes a heat-isolation seat body 11 and a candle-like lampshade 12 which are mounted firmly to each other. The top end of the shade 12 is a recess 1201 which can hold a liquid.

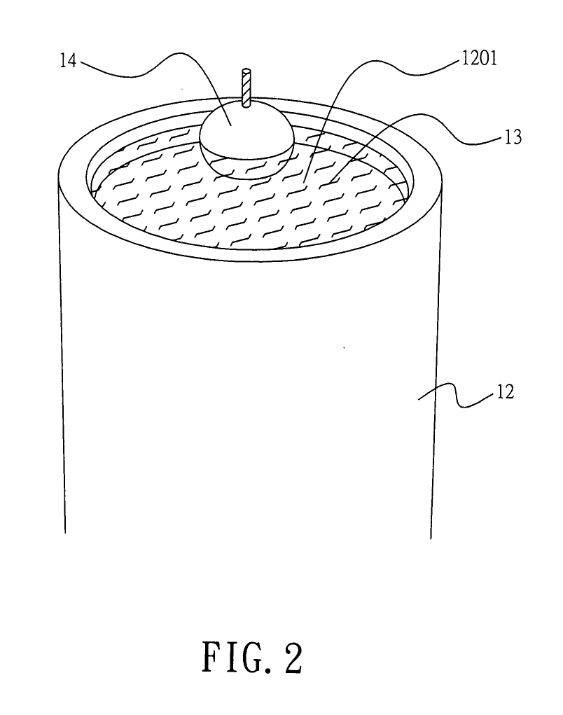

FIG. 2 shows a preferred embodiment in accordance with the present invention. The candle-like lampshade 12 is cylindrical and the top end is a recess 1201 which can hold a liquid 13 which can support a small candle 14. In combination with a light-emitting source 15 (not shown), the light passing through the shade 12 provides a calm ambient to the environment.

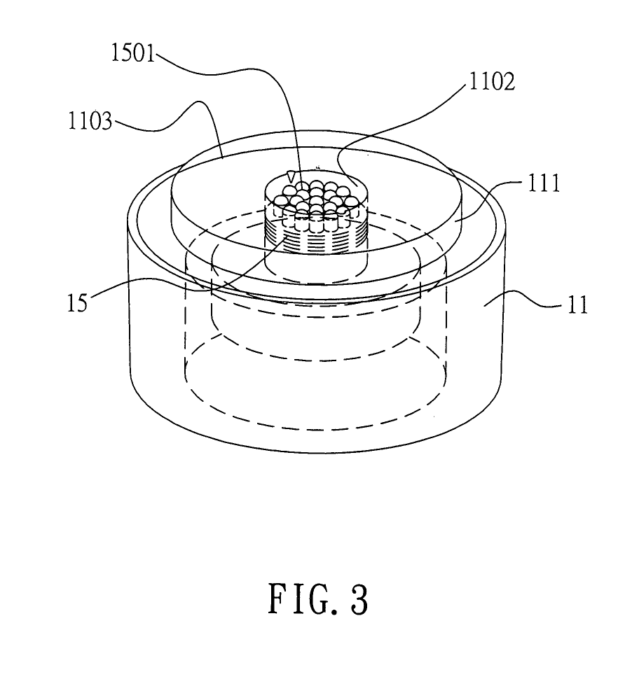

As shown in FIG. 3, there is a schematic view showing the combination of the heat isolation seat body and the light emitting source. The top end of the heat isolation seat body 11 is a protruded mounting edge 1101 mounted with a tapered axle hole 1102. The light-emitting source 15 is secured by inserted from the bottom section of the heat isolation seat body 11, and the interior of the axle hole 1102 is narrower but lower than the horizontal face 1103 of the top end of the protruded mounting edge 1101. The light-emitting source 15 includes LED bulbs 1501. The combination of the heat isolation seat body 11 and the shade 12 to be mounted onto the mounting edge 1101 is a safety consideration for extended period of application. The temperature within the shade 12 is constant such that the shade 12 will not melt.

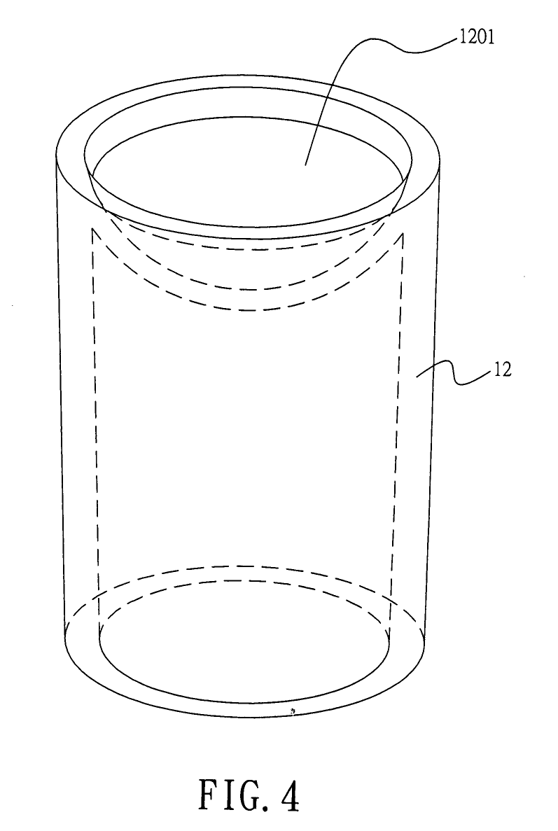

Referring to FIG. 4, there is shown the structure of the shade, wherein the shade 12 is cylindrical and the top end is a recess 1201. The wall of the shade has an appropriate thickness but allows the light to pass through and produce a soft feeling to the environment.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A candle-like lamp having a light-transmitted body comprising a heat isolation seat body, a light-emitting source and a candle-like lamp shade, characterized in that
the heat isolation seat body has an upper end which is a protruded mounting edge and has a tapered axle hole;
the light-emitting source is hidden within the interior of the axle hole but is lower than the horizontal face of the top upper end of the protruded mounting edge; and
the candle-like lamp shade is cylindrical and has an upper end which is recessed and can hold a liquid and is mounted onto the protruded mounting edge of the heat-isolation seat body.
